(19) United States
(12) Patent Application Publication
(10) Pub. No.: US 2012/0048486 A1
(43) Pub. Date: Mar. 1, 2012

(54) Adjustable curtain, blind and cord restrainer

(76) Inventor: David Ian Howarth, Burnley (GB)

(21) Appl. No.: 13/064,665

(22) Filed: Apr. 7, 2011

(30) Foreign Application Priority Data
Aug. 25, 2010 (GB) 1014200.8

(51) Int. Cl. E06B 9/38; F16G 11/00

(52) U.S. Cl. 160/368.1; 24/116 R

(57) ABSTRACT

A restrainer (1. 100) comprises a first arm (3, 103) and second arm (3, 103), and a retaining arm (2, 102) co-operating with the second arm (4) to urge any part of a blind contained between the first arm (2, 103) and the retaining member (2, 102) towards the first arm (3, 103) and to hold said part in place.

In a particular arrangement the third or retaining arm (2) has a T-shaped end piece (17) which engages with the surface of grooves associated with the second arm (4) to lock the third (or retaining) arm in position to retain a part of the blind between the third (or retaining) arm (2) and the first arm (3). The part of the blind can be the blind cord or chain, the blind panels or vanes (14) between the retaining arm (2) and bars (5); in the latter case the retaining member acts upon the panel or vanes (14) to contain the blind cord or chain between bars associated with the first member, the second arm and the blind panels or vanes themselves.

When the blind is closed, retaining arm closed off space between the bars and the first and second members retaining the blind cord or chain in that space.

In another arrangement the restrainer (100) comprises retaining member (102), a hinge pin (117) sliding in grooves (118) in the second arm (102). There is a slot (148) in the front (142) of the second arm through which one end (152) of the retaining member is attached to the hinge pin. The retaining member (102) may thus slide and pivot with respect to the second arm (104), from a locked position to an unlocked position to retain or release louvers or vanes of the blind. Apertures (105) are provided at the rear of the first arm (103) to retain the chains and cords of the blind out of harm's way.

This invention relates to adjustable retainers for curtains and blinds, their components, and for their cords and chains, the invention it was particularly developed as a louver/vertical blind and chain and cord retainer, but it can be used equally for the retention of curtains, curtain operating cords.

IA louver blind system is a style of window furnishing/covering commonly known as vertical blinds. Vertical blinds consist of panels or vanes that hang vertically from a carriage attached to a track or head rail and can be controlled by hand, by the use of an operating cord and operating chain. In this way the panels of the blind can be maneuvered to tilt in order to alter the amount of incoming light or be controlled to compel or detract them along the rail (so as to close and reopen). The operating cord and chain hang vertically from the end of the track containing the cap set and shaft pin. The operating cords and blind panels are weighted to allow them to hang vertically and the panels are joined together at the bottom by bottom chains.

Louver/vertical window blind systems can be fitted in two ways to surrounding structures such as windows and entrances. Firstly in applications to which there is a recess in the surrounding structure, known commonly as “Top fixing” with the use of top clips and secondly in applications to which the surrounding structure is without a recess, known commonly as “Face fixing” by use of a face fixing bracket. Both methods require screw and plug fixings.

The measurements required to fit louver/vertical window blinds relate to the drop (the length of hang required to cover the height of the window or entrance) and the width of the window or entrance. The panels or vanes are usually commercially produced in two widths 89 mm and 127 mm. The width of panel determines the number of panels required or carriages required to hang the panels from ensuring the width of the window is covered so that when installed there are no gaps/daylight between the covering and the surrounding structure.

When there is a requirement to fully open the blinds such as in a conservatory or patio entrance or to open windows, clean windows and let more light in/alter the view, the panels are operated to the ends of the track, (either split draw, to both ends of the track or side draw with panels controlled to one end of the track). In this open setting the panels hang vertically and freely as in the closed setting but are bunched together closer to the surrounding structure.

The free hanging nature of the panels with the bottom chains and the operating cord and chain pose a significant risk of strangulation and injury particularly for toddlers and pets. In addition due to the blind's vertical panels often being made of fabric they are susceptible to movement from wind or passing interference which could result in them becoming a nuisance, noisy, dirty or damaged.

At the moment there are products available to hold back the vertical blind panels to the surrounding structures, there is also a product available to suit both top fixing and face fixing applications. There is a further product of single part containing a safe housing unit for the operating cord and chain. The main problem with the products available is that when fitted to the surrounding structure they protrude from the surrounding structure causing a gap between the covering and the surrounding structure and are only designed to hold up to a certain number of vertical panels.

Similar problems can arise with the operating cords of curtains and valances, and there is a need to restrain both the cords and sometimes the curtains and valances, when they are not being used

The aim of the present invention is to provide a suitable device that can be screw or adhesive fixed to the surrounding structures of both top fixing and face fixing applications without the need for a separate attachment, has means to hold different quantities of vertical panels safely and securely and to secure cords and chains safely, to minimize the associated safety risks.

According to the present invention a restrainer for components of a louver/vertical blind, curtain or valance system comprises a first arm and second arm joined to one another as a bracket, the first and second arms each having a front and rear, the front of the arms facing into the angle of the bracket, and a retaining member co-operating with the second arm to urge any part of a blind contained between the front of the first arm and the retaining member towards the front of the first arm and to hold said part in place.

It is particularly beneficial if the restrainer additionally comprising recesses in the rear of the first arm, said recesses to receive blind cords and/or chains when the restrainer is in use.

In a first embodiment the retaining member is engaged with and, and in the open position, can move with respect to the second arm. In one such an embodiment the retaining member at least two lugs associated therewith engaging in grooves associated with the second arm. In a second embodiment the retaining member is held within a slot in the second arm by a hinge pin. In either case, when the retaining member is in an open position the lugs or hinge are being rotatable with respect to the grooves and when the retaining member is in a closed position the lugs or hinge are held within the grooves. The second arm has a slot in its front through which one end of the retaining member may pass for its lugs to be engaged with the grooves, in the first embodiment, or to be engaged with the hinge, in the second embodiment

In one arrangement of the first embodiment the lugs are the ends of the cross arm of a T-shaped end piece disposed perpendicularly to the retaining member. In this, case engagement of T-shaped end piece with the inner surface of the grooves locks the retaining member arm in place itself to retain a part of the blind between the retaining member and the first arm. Also in such an arrangement the first arm may have one or more vertical bars, and in such a case, and second arm, the bars, and the retaining member when the latter is in one closed position can contain the blind cord or chain between them. In other closed positions of the retaining member, the retaining member may retain curtains, blind panels or vanes between the retaining member and the bars. In such a case the curtain or blind cord or chain may be held between the bars, the blind panels or vanes and the first and second arms.

In this arrangement of the first embodiment, the retaining member may have a lip. The lip has at least one surface recess positioned between the plane of any bars and the second arm; pressure applied to said recess causing slight twisting of the T-shaped end piece with respect to grooves associated with the second arm and leads to frictional engagement of the T-shaped end piece with the grooves.

In the second embodiment, rather than there being lugs or a T-shaped end piece to the retaining member, a hinge is incorporated, sliding in grooves in the second arm, a slot in the front of the second arm enables one end of the retaining member to be attached in the hinge, allowing the retaining member slide and pivot with respect to the second arm.

In the second embodiment further features can be included:
The pivoting movement of the restraining member occurs at one end of the grooves, the retaining member capable of sliding with respect to the grooves sliding in the grooves otherwise than at the ends at which it can pivot;
The hinge has a hinge pin, which can slide in the grooves;
The hinge pin is cylindrical;
The hinge pin cylindrical and mounted top and bottom on guides in the grooves, said guides running along the length of the grooves save at one end where the pin can rotate with respect to the grooves;
The pin has notches top and bottom which are mounted on the guides, preferably the notches are V-shaped and the guides correspondingly shaped;
Body of hinge pin has an aperture to receive a spigot at one end of the retaining member, by which the retaining member is mounted in the hinge pin;
The spigot has a rounded end of greater cross section than the rest of the spigot which rounded end is retained recess within the pin;
The cross section of the aperture is larger than that of the spigot allowing the spigot and thus the retaining member limited rotational movement with the respect to the pin;
The bulbous end of the spigot is spherical with the recess having a corresponding shape to receive said spherical end the spigot;
The length of the spigot is such that when the retaining member is in one position, the spigot between the ball and the remainder of the retaining member is in tension, drawing the ball tight against the rear of the aperture and the said one end of the retaining member into a locked tight against the front of the second arm, retaining it in position against the front of the second arm;
The spherical end of the spigot may have a notch or cut into its surface to allow limited compression to allow the ball to be forced through the aperture in the pin into the recess during assembly of the restrainer.

In the second embodiment, the retaining member may be thickened towards its end adjacent the second arm, to present a blunt end to the front of the second arm, said blunt end bearing on the front of the second member when the retaining member is to be in a locked closed position; and the blunt end having a rounded edge to enable the retaining member to be turned with respect to the pin to release the retaining member from its locked position and allowing the hinge pin to slide within the grooves. When the hinge pin reaches the end of the grooves it pivots with respect to the grooves allowing the retaining member to pivot with respect to the second arm into a fully open position.

In the arrangement described in the preceding paragraph, the surface of the blunt end subtends an angle of about 85° to a lateral surface of the retaining member, which would in the locked position facing the first arm.

In still further development of the second embodiment, the first arm has one or more substantially vertical recesses to receive the a blind cord or the chain, retaining the cord of chain between the first arm and a wall against which it may be mounted, allowing the cord or chain still to move and be operated.

An elongate handle extension may be provided on the retaining member at its outer end to provide for easier operation.

In addition an orthogonal finger plate may extend forward from the retaining member to assist in movement of the retaining member.

Specific embodiments of the invention will now be described by way of example, with reference to the accompanying drawings in which:

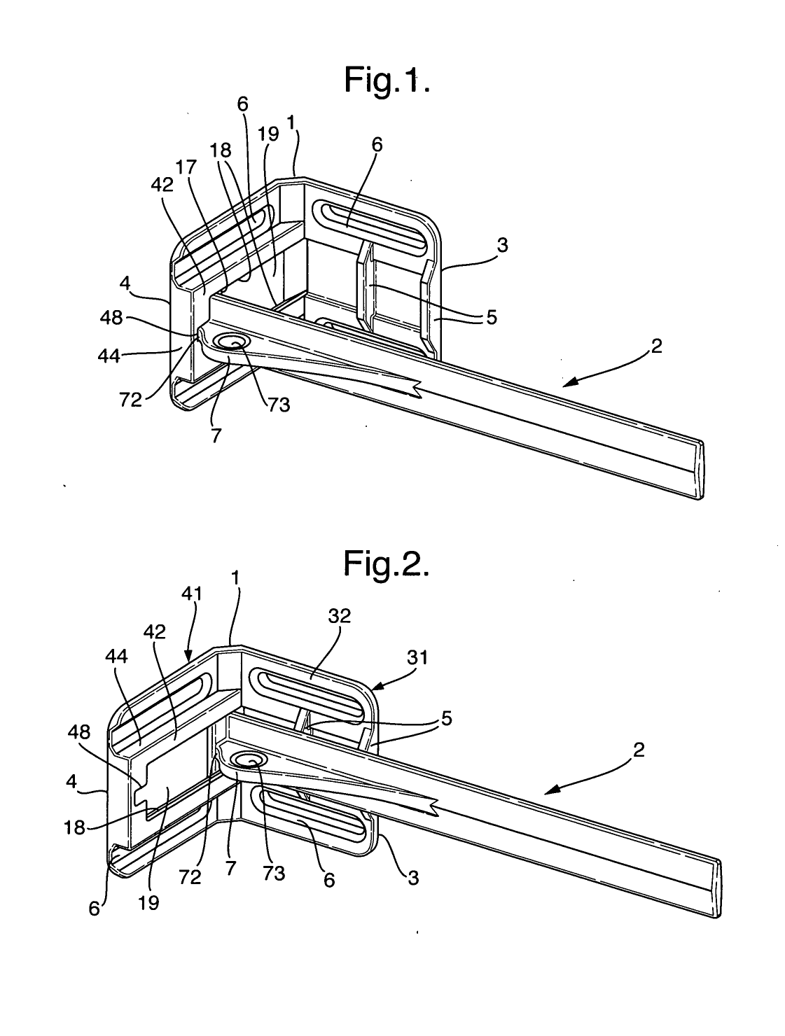

FIG. 1 shows a first restrainer for a louver blind according to the invention with the retaining member in a fully open position;

FIG. 2 shows the restrainer for a louver blind of FIG. 1 with the retaining member in the fully closed position;

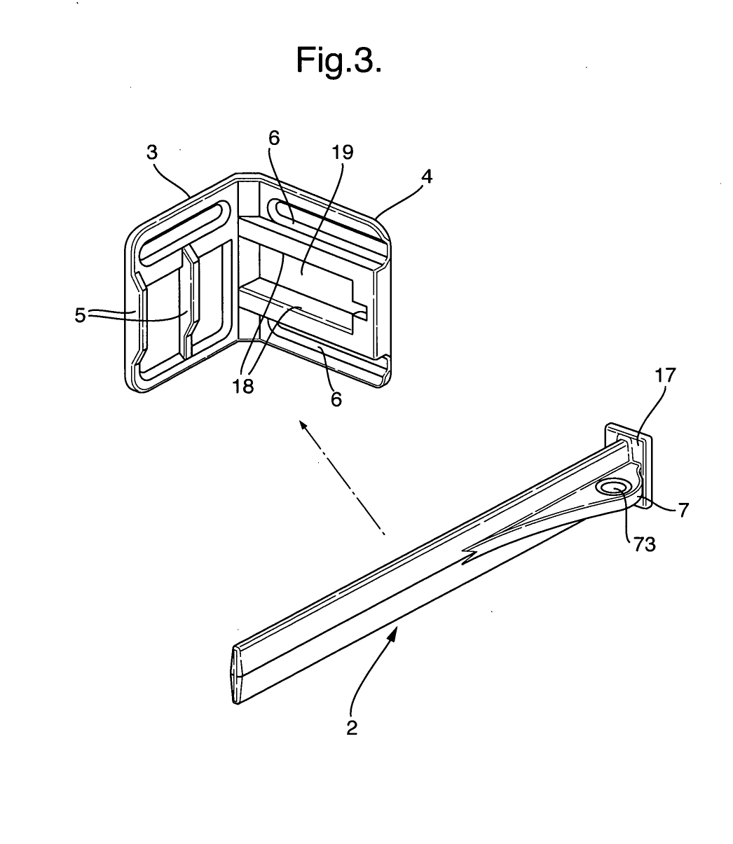

FIG. 3 is similar to FIG. 2 but shows the retainer arm separated from the rest of the device prior to final assembly of the restrainer of FIG. 1;

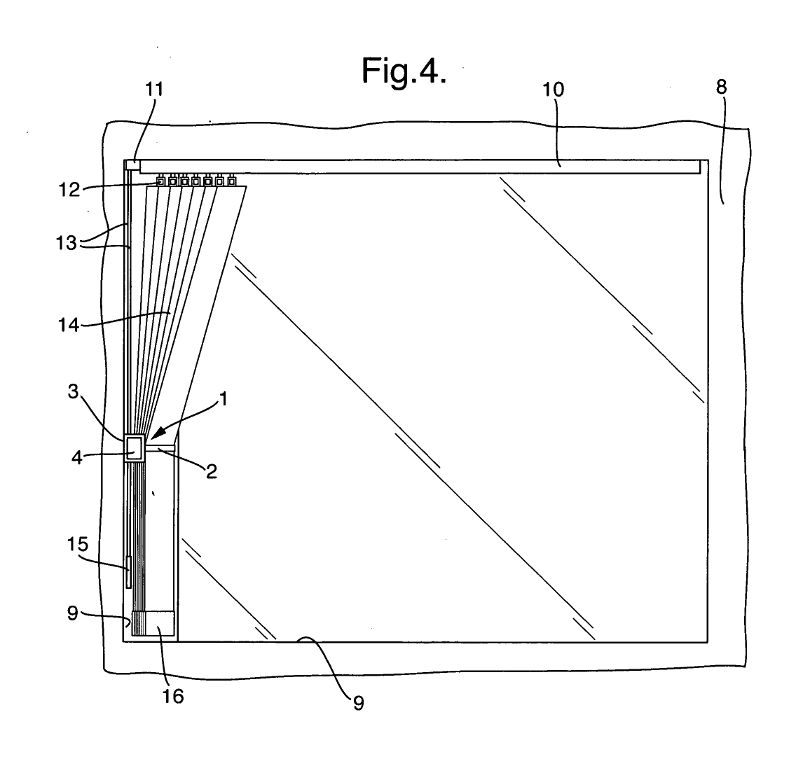

FIG. 4 shows the restrainer for a louver blind of FIGS. 1 and 2 being used in applications where the blind system is fitted inside a recess, with the blind fitted below the top of the recess in the so called “top fixed” position;

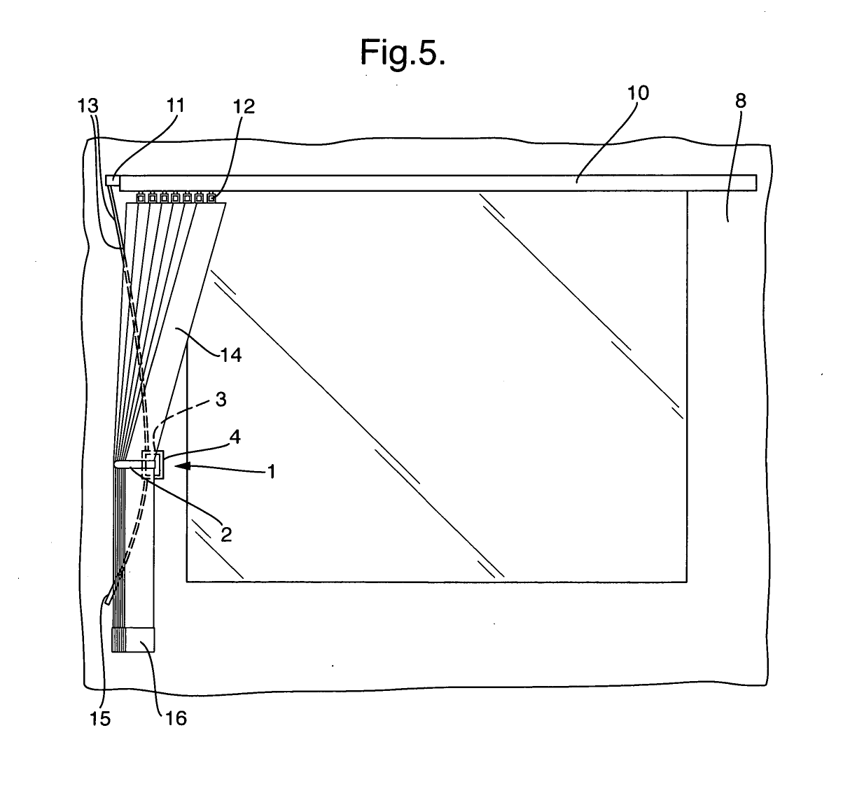

FIG. 5 shows the restrainer for a louver blind of FIGS. 1 and 2 being used in applications where the blind system is fitted without a recess, with the blind fitted in the so called “face fixed” position;

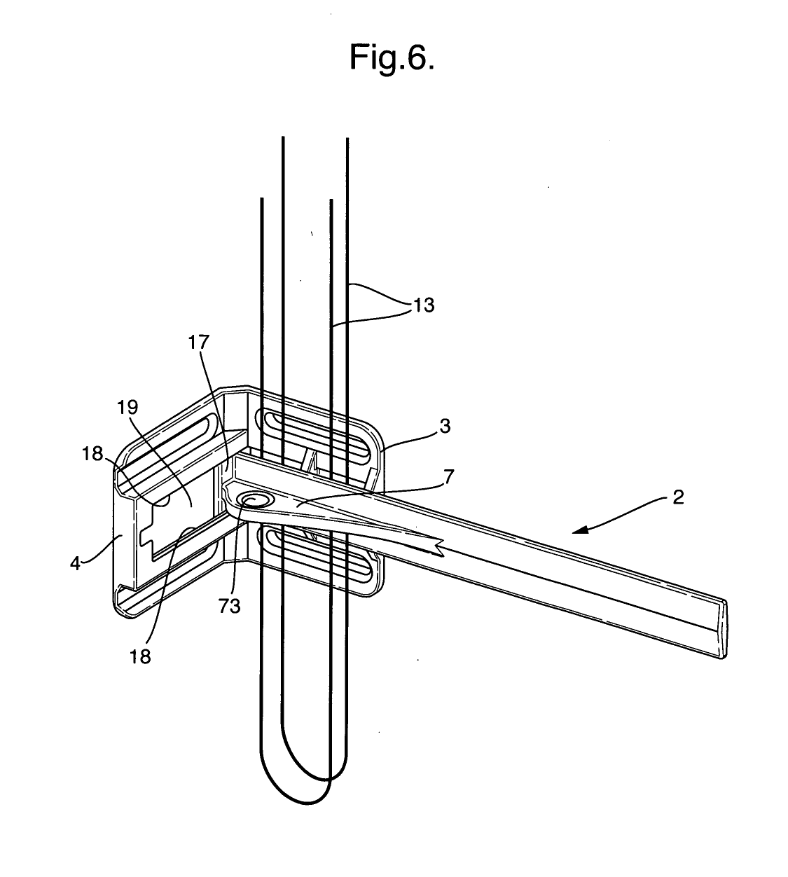

FIG. 6 shows the restrainer for a louver blind of FIGS. 1 and 2 with the retaining member in the closed position to secure the operating cord and chain in either top fixing or face fixing applications;

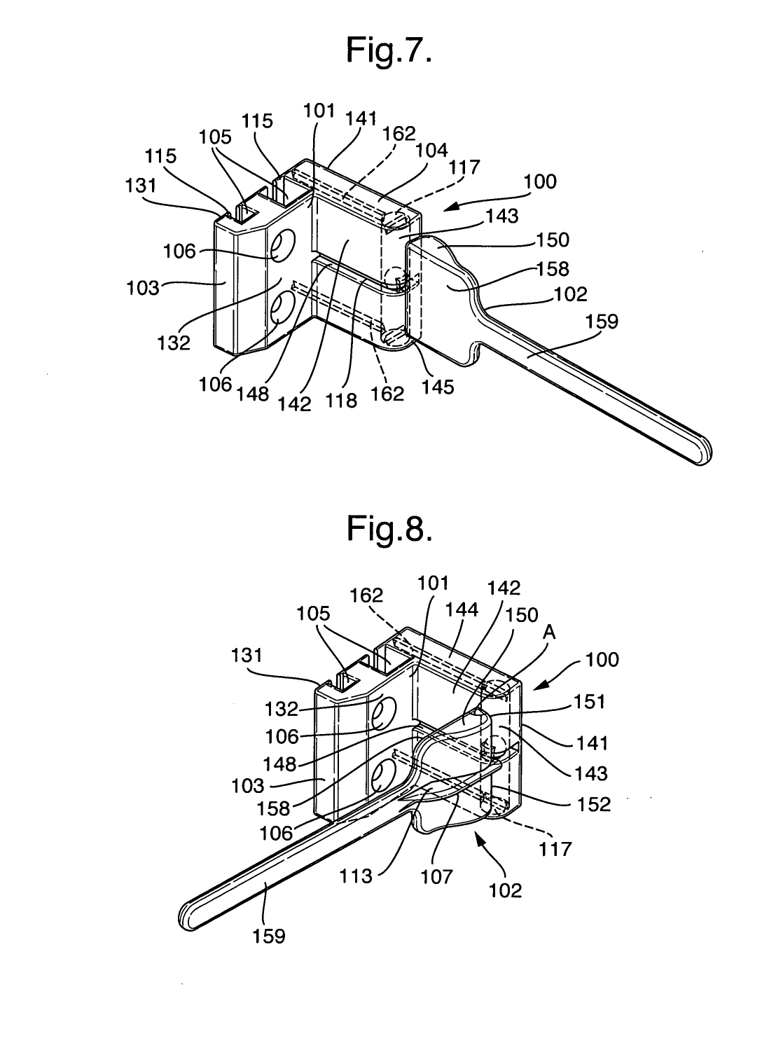

FIG. 7 is a perspective view of a second embodiment of the invention with the retaining member open;

FIG. 8 is a perspective view of the second embodiment of the invention with the retaining member locked, with full capacity between the retaining member and the first arm;

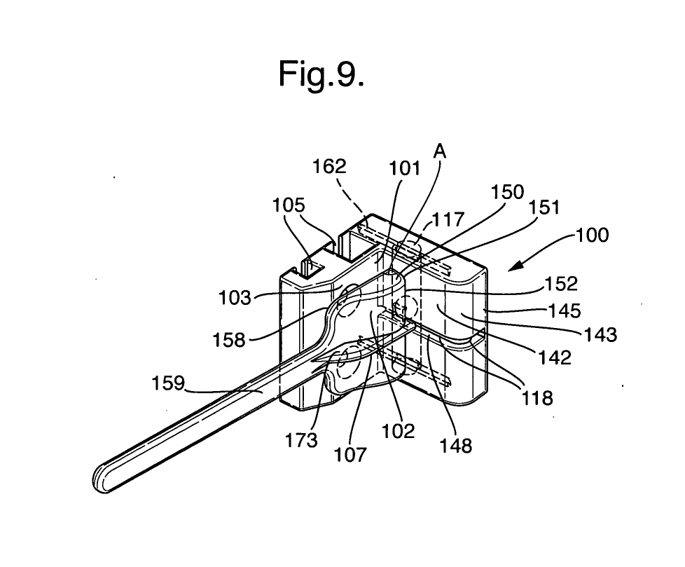

FIG. 9 is a perspective view of the second embodiment of the invention with the retaining member locked, and fully closed;

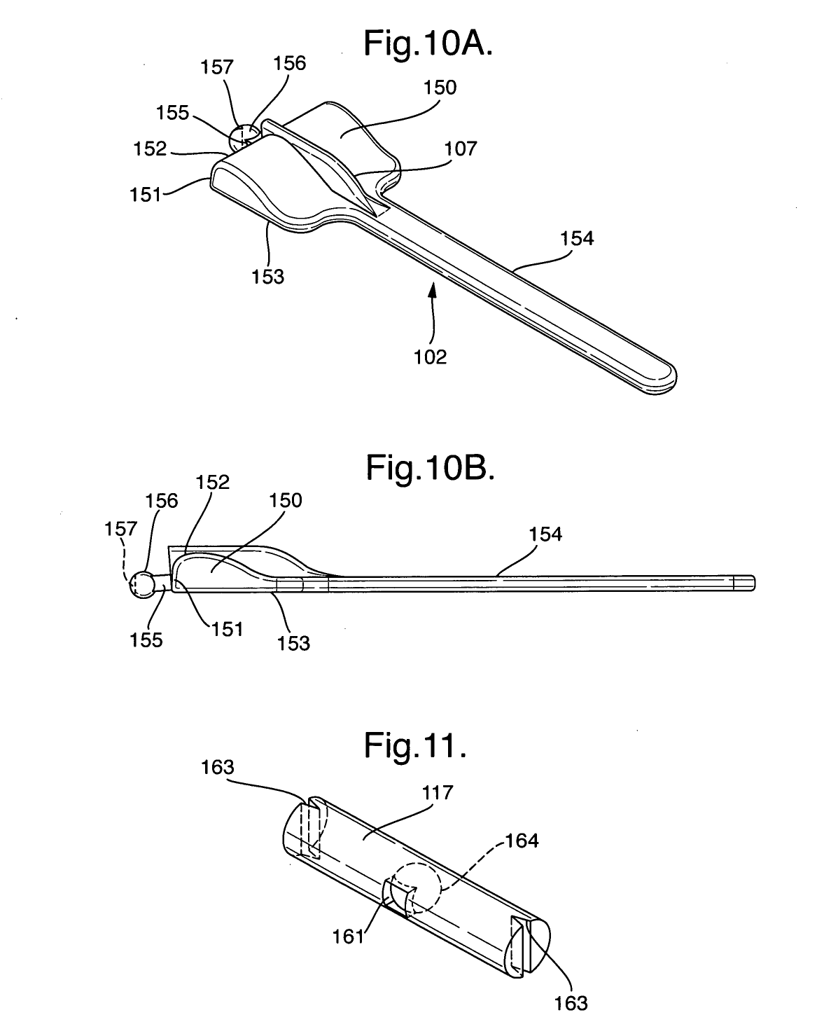

FIGS. 10A and 10B are a perspective view and side view respectively of the retaining member alone of the embodiment shown in FIGS. 7 to 9; and

FIG. 11 is a perspective view of the hinge pin alone of the embodiment shown in FIGS. 7 to 9.

In FIGS. 1 to 3 a restrainer for a louver blind 1 according to the invention comprise a right angled bracket having a first arm 3 and a second arm 4, the rear 31 of the first arm 3 will be engaged against a surface when used with a louver blind fixed in the “top fixed” position, the rear 41 of the second arm 4 will be engaged against a surface when used with a louver blind fixed in the “face fixed” position. Parallel cord securing bars 5, which are generally vertical when the louver blind restrainer 1 is attached to a surface, are molded on the front 32 of arm 3. Pairs of parallel channels 6 are formed in each of the arms 3 and 4, the inside edges of which are countersunk to receive fixing screws to enable the device 1 to be fixed to a wall.

A rectangular box-like molding 44 is provided on second arm 4 to form a grooves 18 top and bottom of an 19 the grooves behind the front of the box 44. The front of the box is thus the front 42 of arm 4. A square cut out 48 is formed at the front 42 at the side of aperture 19 away from the angle between arms 3 and 4.

A retaining member 2, which is horizontal when the restrainer 1 is fixed in position, has T-shaped end 17, the arms of the T engaging in the grooves 18 such that retaining member 2 can slide towards or away from first arm 3.

Retaining member 2 has an inside molded shaped lip 7 adjacent T-end 17 grooves in aperture 19. Lip 7 is oriented such that it is orthogonal to the arms of the T-shaped end 17 and retaining member 2. Lip 7 has a square cut out portion 72 in its edge 7, said cut out 72 being of size to be an interfering engagement with the matching cut out 48 of molding 44.

In an open position, when the restrainer is not being used to hold a louver blind, the end of lip 7 with its cut out portion 72, engages in cut out 48. Interference between the perimeter of the lip 7 and cut out 48 retains the retaining member 2 in this position until the device is to be used.

Retaining member 2, with its molded lip and T-shaped end 17, are molded separately from the rest of the device. To fit the retaining member it is held at 90° to its normal operating position, with the T-shaped end 17 in aperture 18. It is then twisted and twisted so the arms of T-shaped end 17 engage the groove top and bottom of aperture 18.

The lip 7 also has an indentation 73 on at least one surface to receive the finger and/or thumb of a user and help with the maneuvering of the retaining member 2. This detail can be seen more clearly in FIG. 3. The indentation is positioned to be between planes passing through bars 5 and perpendicular to arm 3, and the plane containing arm 4. In this way thrust applied through lip 7 at the indent 73 will tend to twist the cross arm of T-shaped end piece 17 in grooves of aperture 18, end movement of retaining member 2 towards arm 3 is resisted, for example when the retaining member 2 meets bars 5. The twisting movement will tend to lock the T cross arm of T-end piece 17 in position.

In FIG. 4 the device used in connection with a “top fixed” louver blind and in FIG. 5 with a face fixed louver blind. In both cases the blind panels and vanes 14 are mounted by carriages 12 in a track 10 (also known as a head rail). The track has an end cap 11 housing a conventional mechanism for converting the movement of a loop cord or chain 13 around the perimeter of a drive wheel into movement of the carriages 12 to and fro from a blind closed position to a blind open position and vice-versa within track 10. The cord or chain hangs down under gravity from the end cap 10. The blind is fitted with a conventional operating cord and chain weight 15 and bottom weights 16 for the blind panels or vanes.

In FIG. 4 the restrainer for a louver blind 1 is fixed by screws though the parallel channels 6 in first arm 3 to the inside surface of a recess 9. In FIG. 5 the louver blind restrainer 1 is fixed by screws though the parallel channels 6 in arm 4 to the wall 8. In both cases, the device 1 is fixed so that arms 3 and 4 and channels 6 are horizontal. It should be noted that although in this example the device is fixed by screws, it can be glued in place, if this is preferred.

In operation, when the blind is in the open position, the panels or vanes 14 are gathered between retaining member 2 and second arm 4. The cord or chain is placed between second arm 4 and the now upright bars 5 on first arm 3. Retaining member 2 is now pressed into the gathered bundle of panels or vanes 14. The back pressure twists the T-shaped end 17 of retaining member 2 very slightly in the grooves such that friction between the T-shaped end 17 and the inner surfaces of the grooves 18 holds the retaining member 2 in place. The cord or chain is held between the panels or vanes 14, bars 5 and arm 3 and 4 out of reach. To release the panels or vanes 14, the retaining member 2 is urged very slightly forward to release the friction and then eased back. This action makes the cord or chain 13 available to operate the blind.

An important aspect of the restrainer for a louver blind according to the invention is its ability safely to stow blind loop cords or chains 13 while the blind is closes, or partially closed. This is shown in FIG. 6. Here two loop cords or chains 13 are shown hanging from end caps of the blind. These are arranged between the bars 5 and the arms 3 and 4 as shown. Retaining member 2 is moved towards arm 3 to engagement with bars 5. Pressure is applied though the finger/thumb indents 73 on lip 7 to urge the T-shaped end 17 a little closer to first arm 3, letting go of finger/thumb indents 73 allows the arms of the T of T-shaped end 17 to twist very slightly in the grooves of aperture 18 under reverse pressure from the bars, to cause the T-shaped end 17 and thus retaining member 2 to become held in place by friction. To release the cord or chains 17, retaining member 2 is pushed slightly forwards through the finger/thumb indents 73 and then eased back as before.

To assist with retaining the arms of the T-shaped end 17 in place, a series of small detents can be provided on the inside surface of one or both grooves in aperture 18.

In FIGS. 7 to 9 an alternative embodiment is shown, a restrainer for a louver blind 100 according to the invention comprise a right angled bracket 101 having a first arm 103 and a second arm 104. The rear 131 of the first arm 103 will be engaged against a surface when used with a louver blind fixed in the “top fixed” position, the rear 141 of the second arm 104 will be engaged against a surface when used with a louver blind fixed in the “face fixed” position. Parallel cord apertures 105, which are generally square or rectangular cross section and vertical when the louver blind restrainer 1 is attached to a surface, are molded into rear 131 of first arm 103. Pairs of countersunk screw holes 106 are formed through the first arm 103, to receive fixing screws to enable the device 100 to be fixed to a wall. Alternative arrangements whereby the device can be mounted to a wall when the louver blind is face fixed are discussed below.

Second arm 104 formed with a molded rectangular box-like molding 144 between its front 142 and rear 141, with grooves 118 formed in the box molding between the front 142 and the rear 141. A horizontal slot 148 in the front face is formed in the front face 101 of the arm 104, allows access to the grooves, and to a corresponding slot (not shown) in the rear 141. This latter slot is countersunk on its edges within the box to receive screws passed through the slot 148 to enable the device to be mounted on a wall in a face fixed mode.

A retaining member 102, which is horizontal when the louver blind restrainer is fitted to arm 104 using grooves 118 as described below. In an open position, as shown in FIG. 7, when the restrainer for a louver blind 100 is not being used to restrain a louver blind, the retaining member 102 can swing about the second arm 104 to a position in which is substantially aligned with the second arm 104. In a closed full capacity position as shown in FIG. 8 (with vanes of a louver a blind retained between the retaining member 102 and first arm 103—the louvers have been omitted from this figure for clarity), the retaining member 102 is locked with its blunt end 150 abutting the front of second arm 104. In practice, the blunt end 150 of the retaining member subtends an angle of about 85° to the face 158 of the retaining member facing the first arm 103, so that a handle 159 at the outer end of the retaining member 102 away from second arm 104 points out away from first arm 103 very slightly. Once the vanes of the blind are held between the retaining member 102 and the first arm, 103 there is no movement or flexibility of any kind in the retaining arm, until it is released. The finger plate 107, formed as a longitudinal spine of on the retaining member 102, assists in imparting the necessary rigidity to the retaining arm. FIG. 9 also shows the retaining member 102 in a locked position, but closed without any louvers between the retaining member and the first arm.

A cylindrical hinge pin 117 (shown in detail in FIG. 11) is mounted top and bottom within grooves 118. The top and bottom of the hinge pin 117 have V-shaped cutouts 163 which are received onto correspondingly shaped guides 162 top and bottom of the grooves and running along the length top and bottom of the grooves 118 to stop short by a distance the width of the hinge pin form the end of the grooves. At this end 143 the front 142 of second arm 104 curves backward to join the back 141, forming at the end of grooves 118 a space in which the hinge pin 117 can pivot free of the guides 162. As the retaining member is released to its open position in FIG. 7, the hinge pin 117 pivots in the end 143, to a point where notches 163 are at right angles to the guides 162. At the retaining member 102 is returned towards it locked position, the notched 163 are aligned with the guides 162 and the hinge pin can slide one again within grooves 118.

The hinge pin has a rectangular aperture 161, with a spherical recess 164 behind it within the pin. Aperture 161 is about half way along the length of the pin.

A rectangular spigot 155 (FIG. 10) extends from the proximal end of retaining member 102, with a sphere 156 molded at its end. The spigot 155 and sphere 156 pass through slot 148 in the front of the second arm 104 to engage though aperture 161 so that sphere 156 is in the recess 164 of the pin. Aperture 161 has a slightly greater cross section than the spigot 155, allowing retaining member 102 some limited pivotal movement with respected to pin 117 even though movement of the pin 117 is restricted by guides 162. To assist assembly of the restrainer, sphere 156 has a notch or cut 157 into its surface to allow limited compression to allow the sphere 156 to be forced through the aperture 161 into the recess 164.

The retaining member 102 is thickened towards its end 152 adjacent the second arm 104, to present a blunt end 150 to the front 142 of second arm 104. The blunt end 150 bears on the front 142 when the retaining member is a locked closed position (as shown in FIG. 8 or 9). The blunt end 150 has a rounded edge 151 to enable the retaining member 102 to pivot slightly about recess 164 with respect to the pin 117 to release the retaining member from its locked position and allowing the hinge pin 117 to slide within the grooves 118. When the hinge pin reaches the end of the grooves it can pivots with respect to the grooves, as already described allowing the retaining member 102 to pivot with respect to the second arm 104 into a fully open position as shown in FIG. 7.

In the arrangement described in the preceding paragraph, the blunt end 150 subtends an angle of about 85° to the surface 158 facing the first arm 103 when the retaining member 102 is in its locked position. The handle 159 can be used to pull the retaining member 102, when in its locked position, causing slight pivoting of the retaining member 102 about pin 117, so releasing the retaining member from its locked position.

Handling of the device is further helped by the presence of an orthogonal finger plate 107 extending forward from the retaining member to assist in movement of the retaining member.

It should be noted that the length of the spigot 155 is such that when the retaining member is in a locked position (as in FIGS. 8 and 9), the length of the spigot 155 between the sphere and blunt end 150 is such that the spigot is in slight tension, with the sphere 156 bearing on the wall of recess 164, and the blunt end 150 bear on the front 142 of the second arm 104.

When the restrainer is mounted on a wall, the operating cords and chains can be retained behind arm 103 in the apertures 105, safely kept away from children. To assist this when the restrainer is in use with a wall mounted blind, and the second arm 104 is mounted against a wall, the apertures 105 are provided with lips 115, to partially close. For a top fixed blind, first arm 103 will be mounted against the wall, and the wall itself will close the apertures.

The devices described herein can be made from any manner of materials; plastics suitable for injection molding are useful. Existing devices have been made by injection molding glass filled nylon, but polycarbonates and polythene are all practical materials for the injection molding of these devices. In the figures the invention has been described with particular reference to louver blind systems. However the systems described can be applied equally to curtains and their cords, and valances and their cords. For example in FIGS. 4 to 6 the vanes 14 could equally be a curtain. Likewise in FIG. 8 where the retention of vanes of a louver blind is described, tis can be a curtain.

In addition to the specific arrangements described to allow the retaining arm to be manoeuvred with respect to the second arm, other arrangements will be apparent to those skilled in the field such as a roller, ratchet and spring and button arrangement. These other approaches fall within the scope of the present invention.

1. A restrainer for components of a louver/vertical blind, curtain or valance system comprising a first arm and second arm joined to one another as a bracket, the first and second arms each having a front and rear, the front of the arms facing into the angle of the bracket, and a retaining member co-operating with the second arm to urge any part of a blind contained between the front of the first arm and the retaining member towards the front of the first arm and to hold said part in place.

2. A restrainer according to claim 1 wherein the retaining member subtends an angle of between about 80° and 90° to the face of the second arm when the retaining member is in a locked position.

3. A restrainer according to claim 1 additionally comprising recesses in the rear of the first arm, said recesses to receive blind cords and/or chains when the restrainer is in use.

4. A restrainer according to claim 1 additionally comprising a finger plate on the retaining member said finger plate acting as a spine for the retaining member.

5. A restrainer according to claim 1 wherein the retaining arm, in an unlocked position, may move relatively with respect to the second arm towards and away from the first arm.

6. A restrainer according to claim 5 wherein the retaining member has at least two members extending from the top and bottom edge of the retaining member engaging in grooves in the second arm.

7. A restrainer according to claim 6 wherein the retaining arm has a T-shaped end piece retaining the arms of said T-shaped end piece extending form the top and bottom edge of the holding arm and forming said members and engaging in grooves in the second arm.

8. A restrainer according to claim 7 wherein said T-shaped end piece co-operates with the inner surface of the grooves associated with the second arm to lock the or retaining arm in position to retain a part of the blind between the retaining member and the first arm.

9. A restrainer according to claim 1 comprising additionally comprising grooves in the second arm between the front and the back of second arm, a hinge pin sliding in said grooves, a slot in the front the second arm through which one end of the retaining member is attached to the hinge pin, and wherein the retaining member may slide and pivot with respect to the second arm.

10. A restrainer according to claim 9 wherein the pivoting is at one end of the grooves.

11. A restrainer according to claim 9 comprising a hinge pin, which can slide in the grooves.

12. A restrainer according to claim 9 comprising a cylindrical hinge pin mounted top and bottom of the grooves on guides in said grooves, said guides extending the length of the grooves save at one end where the hinge pin can rotate with respect to the grooves.

13. A restrainer according to claim 12 additionally comprising notches top and bottom of the hinge pin, said notches being capable of engaging in the guides.

14. A restrainer according to claim 9 comprising a cylindrical hinge pin and wherein the hinge pin has an aperture to receive a spigot at the one end of the retaining member adjacent the second arm by which spigot the retaining member is mounted in the hinge pin, said spigot having a rounded end of greater cross section than the rest of the spigot, which rounded end is retained in a recess within the hinge pin, and in which the cross section of the aperture is larger than that of the spigot allowing the spigot and thus the retaining member limited rotational movement with the respect to the hinge pin.

15. A restrainer according to claim 14 wherein the rounded end of the spigot is spherical and the recess is correspondingly spherical.

16. A restrainer according to claim 15 wherein the length of the spigot is such that when the retaining member is in a locked position the spigot between its spherical end of the spigot and the remainder of the retaining member is in tension, drawing the spherical end tight against the rear of the aperture and the said one end of the retaining member against the front of the second arm retaining it in position.

17. A restrainer according to claim 16 wherein the spherical end of the spigot may have a notch or cut into its surface to allow limited compression to allow the spherical end to be forced through the aperture in the pin into the recess during assembly of the restrainer;

18. A restrainer according to claim 9 wherein the retaining member has a thickened portion towards its end adjacent the second arm, the thickened portion having a blunt end, said blunt end bearing on the front the second arm when the retaining member is in a locked closed position; and said blunt end having a rounded edge to enable the retaining member to be turned slightly to be released from its locked position.

19. A restrainer comprising,
a first arm and second arm joined to one another as a bracket, the first and second arms each having a front and rear, the front of the arms facing into the angle of the bracket, and a retaining arm co-operating with the second arm to urge any part of a blind contained between the first arm and the retaining arm towards the first arm and to hold said part in place;
grooves in the second arm between the front and the back of second arm,
a cylindrical hinge pin mounted top and bottom of the grooves on guides in said grooves, said guides running along the length of the grooves save at one end where the hinge pin can rotate with respect to the grooves sliding in grooves in the second arm;
the hinge pin having notches top and bottom which engage with the guides;
a slot in the front of the second arm through which one end of the retaining member is joined to the hinge pin, and wherein the retaining member may slide and pivot with respect to the second arm;
the hinge pin having an aperture in which a spigot at said one end of the retaining member is received and by which spigot the retaining member is mounted in the hinge pin;
said spigot having a rounded end of greater cross section than the rest of the spigot, which rounded end is retained in a recess within the hinge pin, and in which the cross section of the aperture is larger than that of the spigot allowing the spigot and thus the retaining member limited rotational movement with the respect to the hinge pin;
a length of the spigot such that when the retaining member is in a locked position the spigot between its rounded end and the remainder of the retaining member is in tension, drawing the rounded end tight against the rear of the aperture and the said one end of the retaining member against the front of the second arm holding the retaining member in position.
the retaining member having a thickened portion towards said one end, with a blunt end formed at said one end, said blunt end bearing on the front of the second arm when the retaining member is in a locked closed position; said blunt end having a rounded edge allowing the retaining member to be turned slightly to be released from its locked position;
the blunt end subtending an angle of about 85° to the front of the first arm, when the retaining members in a locked position.

20. A restrainer according to claim 19 additionally comprising recesses in the rear of the first arm, said recesses to receive blind cords and/or chains when the restrainer is in use.
